(19) United States
(12) Patent Application Publication
(10) Pub. No.: US 2009/0159625 A1
(43) Pub. Date: Jun. 25, 2009

(54) Equipment rack for boats

(76) Inventor: Arthur P. Pearce, Midway, GA (US)

Correspondence Address: LITMAN LAW OFFICES, LTD., POST OFFICE BOX 15035, CRYSTAL CITY STATION, ARLINGTON, VA, 22215-0035, US

(21) Appl. No.: 12/003,217

(22) Filed: Dec. 20, 2007

(51) Int. Cl. B63B 17/00; B60R 7/00

(52) U.S. Cl. 224/406; 114/343

(57) ABSTRACT

The equipment rack for boats is adapted for mounting to a lower surface of the roof of a boat. A conventional equipment housing may be suspended from the rack. The equipment rack allows for the lowering of the equipment housing to a height that is easily accessible by the user. The equipment rack includes a plurality of openings for the removable reception and support of chart storage tubes and other marine related equipment. The equipment rack may have a substantially rectangular shape and may be formed from any suitable material, such as teak, plastic or the like. Preferably, the equipment rack has a height between six and ten inches, allowing for the lowering of the equipment housing by six to ten inches from its conventional position.

### BACKGROUND OF THE INVENTION

1. Field of the Invention

The present invention relates to boating accessories, and particularly to an equipment rack for storing and supporting charts and other marine related equipment.

2. Description of the Related Art

Boats, such as T-top style boats, typically include roof-mounted equipment housings. Such housings are provided for holding navigational equipment, computers, displays and the like. The housings may further be provided as conventional storage housings. Equipment housings are typically mounted to a lower surface of the roof so that the housing is positioned above the head of the user for access while the user is piloting the boat. However, conventional housings are often mounted at a level that is inconvenient for reach and access by the user. It would be desirable to provide a support for lowering the conventional equipment housing, allowing the user to access the equipment housing in a comfortable and safe manner.

Additionally, conventional housings are designed only to hold specific equipment, such as the navigational computer or the like. It would be desirable to provide additional support and storage for other pieces of marine related equipment, such as charts, chart holders, nets, gaffs and the like. Thus, an equipment rack for boats solving the aforementioned problems is desired.

### SUMMARY OF THE INVENTION

The equipment rack for boats is a rack that is adapted for mounting to the lower surface of the roof of a boat. T-top style boats, in particular, typically include an equipment housing mounted to the lower surface of the roof for positioning equipment, such as navigational computers and the like, above the head of the user. The equipment rack is mounted to the lower surface of the roof, and the equipment housing is secured to a lower surface of the rack, rather than directly to the roof, in order to lower the equipment housing for the convenience of the user. The rack preferably has a height of approximately six inches, thus positioning the equipment housing six inches closer to the user from the conventional position.

The equipment rack further allows for the storage of navigational charts and other marine related equipment therein. The equipment rack includes at least one wall having a pair of laterally opposed surfaces and a pair of longitudinally opposed surfaces, with at least one pair of openings being formed through the pair of longitudinally opposed surfaces. Connectors are provided for securing the upper surface of the at least one wall to the roof of the boat and for securing the lower surface of the at least one wall to an upper surface of the equipment housing associated with the boat. Charts and other equipment, such as gaffs, nets and the like, may be stored within the at least one opening formed through the wall.

These and other features of the present invention will become readily apparent upon further review of the following specification and drawings.

### BRIEF DESCRIPTION OF THE DRAWINGS

FIG. 1 is an environmental, perspective view of an equipment rack for boats according to the present invention.

FIG. 2 is a detailed environmental, perspective view of the equipment rack for boats according to the present invention.

FIG. 3 is a perspective view of the equipment rack for boats according to the present invention.

FIG. 4 is a perspective view of the equipment rack for boats according to the present invention, shown holding a plurality of chart storage tubes.

FIG. 5 is an exploded perspective view of a chart storage tube for storing a chart in an equipment rack for boats according to the present invention.

FIG. 6 is an exploded environmental perspective view of the equipment rack for boats according to the present invention.

FIG. 7A is a top view of the equipment rack for boats according to the present invention.

FIG. 7B is a bottom view of the equipment rack for boats according to the present invention.

Similar reference characters denote corresponding features consistently throughout the attached drawings.

### DETAILED DESCRIPTION OF THE PREFERRED EMBODIMENTS

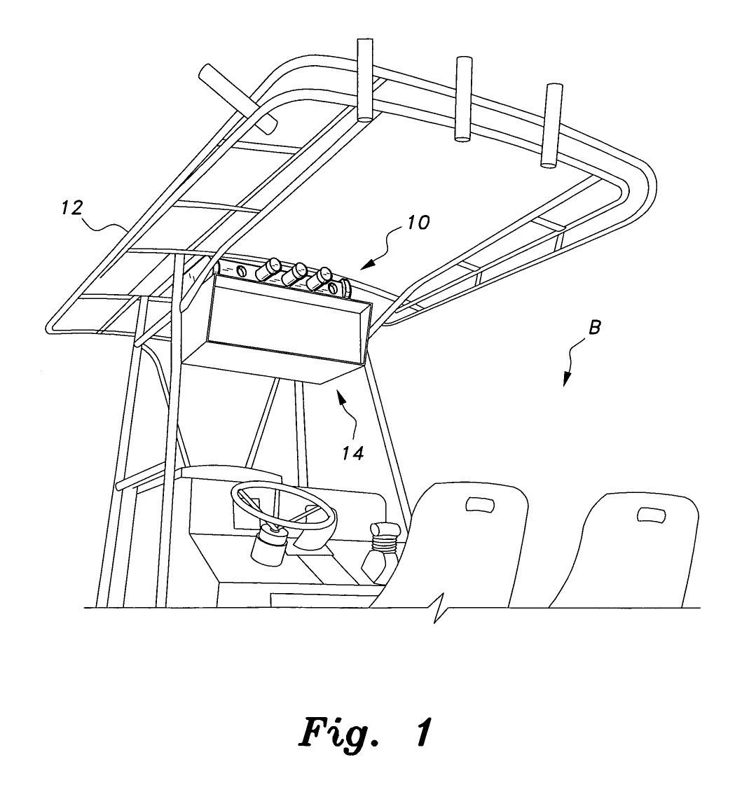

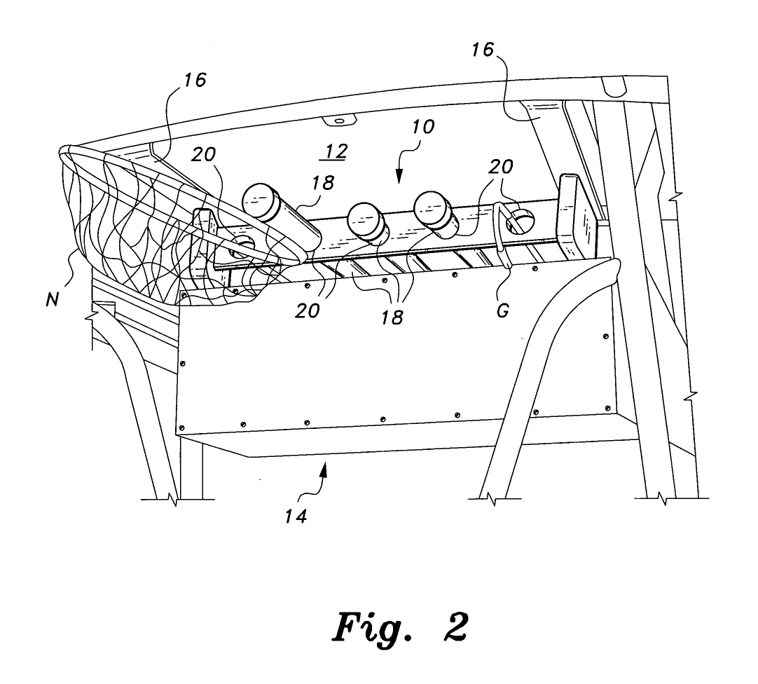

The present invention is directed towards an equipment rack for boats 10. The equipment rack for boats 10 is a support rack that is adapted for mounting to the lower surface of the roof 12 of a boat B, as shown in FIG. 1. T-top style boats, in particular, typically include an equipment housing, such as exemplary housing 14, which is conventionally mounted directly to the lower surface of the roof and comprises a shelf for positioning equipment, such as navigational computers and the like, above the head of the user. As shown in FIGS. 1 and 2, with the present invention, the equipment rack 10 is mounted directly to the lower surface of the roof 12, and the equipment housing 14 is secured to a lower surface of the rack 10, rather than directly to the roof 12 (as is common in conventional boats), in order to space the equipment housing 14 lower for the convenience of the user. The rack 10 preferably has a height of approximately six inches, thus positioning the equipment housing 14 six inches closer to the user from the conventional roof-mounted position. It should be understood that boat B, roof 12 and housing 14 are shown for exemplary purposes only, and that rack 10 may be used in combination with any desired boat roof style or with any type of equipment housing.

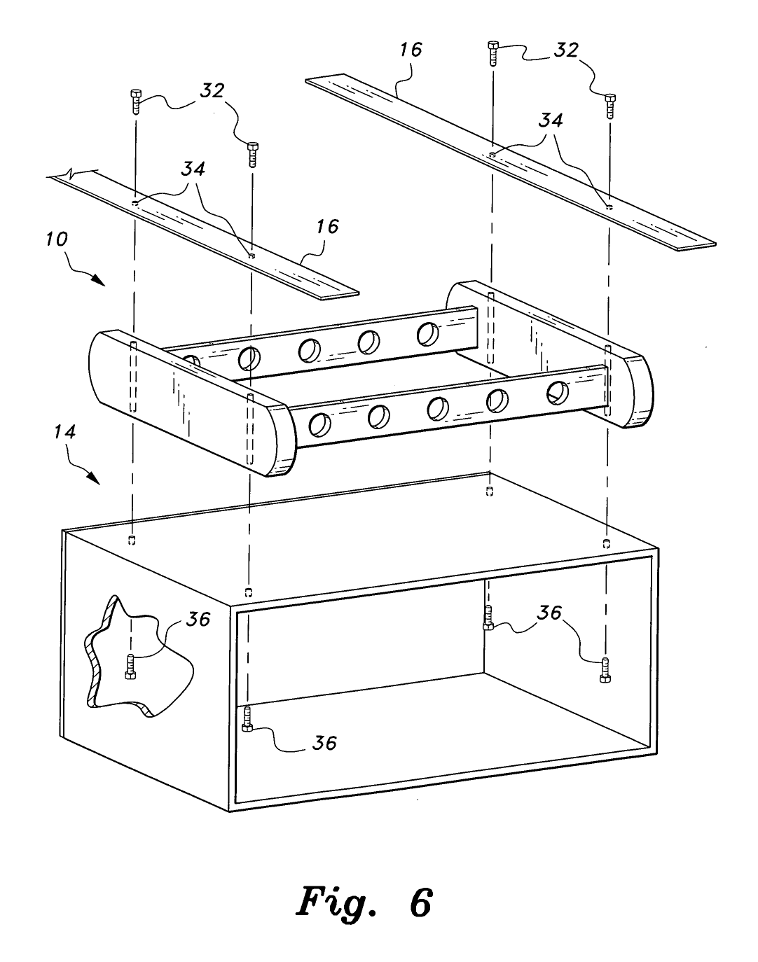

The equipment rack 10 provides storage space for navigational charts and other marine-related equipment therein, as will be described in greater detail below. The equipment rack 10 includes at least one wall having a pair of laterally opposed surfaces and a pair of longitudinally opposed surfaces, with at least one pair of openings 20 being formed through the pair of longitudinally opposed surfaces. As will described in greater detail below (particularly with regard to FIG. 6), connectors are provided for securing the upper surface of the at least one wall to the roof 12 of the boat B and for securing the equipment housing 14 to the lower surface of the equipment rack 10. Charts C and other equipment, such as gaffs G, nets N and the like, may also be stored within the at least one opening 20.

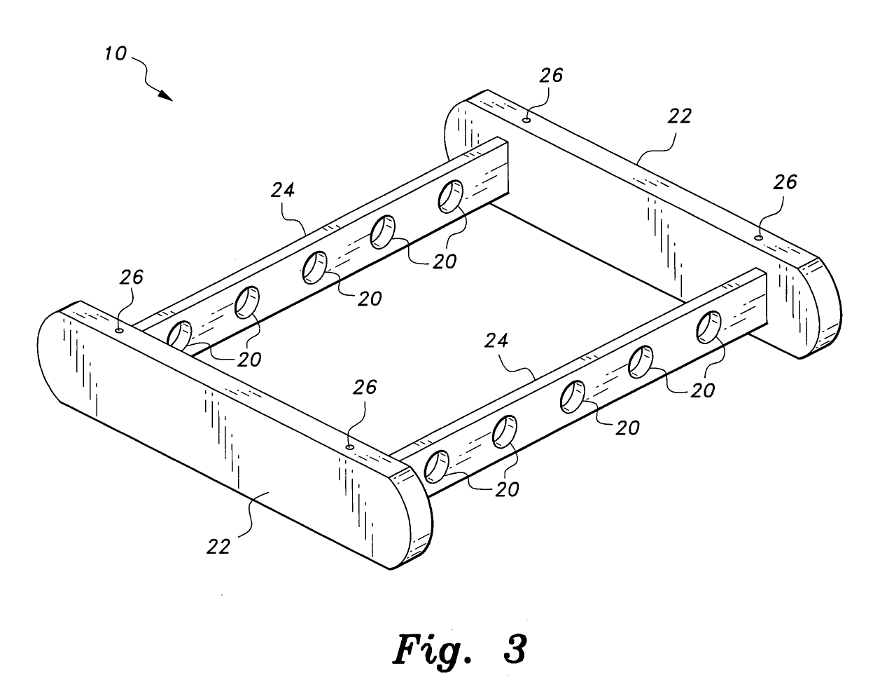

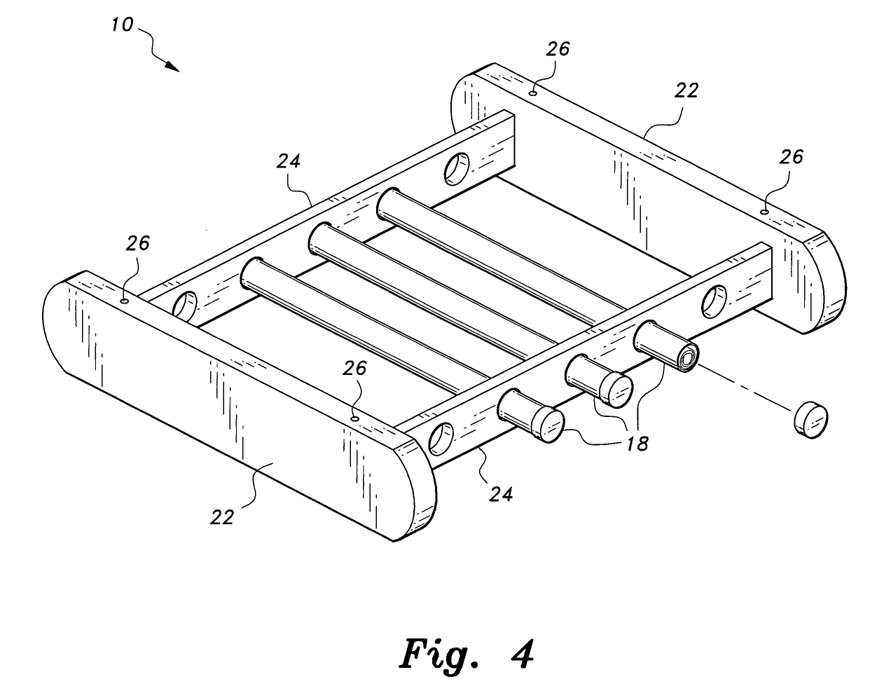

As shown in FIGS. 3 and 4, the at least one wall includes a pair of longitudinally opposed rails 24 and a pair of laterally opposed beams 22 forming a generally rectangular frame. The rails 24 are secured to the beams 22 through the use of any suitable fasteners, such as screws, nuts or the like.

As shown in FIGS. 3 and 4, in the preferred embodiment, opposed ends of each of the rails 24 are secured to inner surfaces of the beams 22, and each of the rails 24 is spaced apart from longitudinally opposed ends of the beams 22. It should be understood that the particular shape, arrangement and dimensions of the rails 24 and beams 22 may vary from that shown in the drawings. The rack 10 may be formed from any desired material, such as, for example, teak, plastic or the like.

As best shown in FIGS. 3 and 4, the openings 20 are formed through the pair of longitudinally opposed boards 24, with each pair of openings 20 being longitudinally aligned. The exemplary rack 10 shown in the drawings includes five pairs of longitudinally opposed openings 20, although it should be understood that the number of openings may vary. Further, the size and shape of the openings 20 may vary, depending upon the nature of equipment to be stored therein.

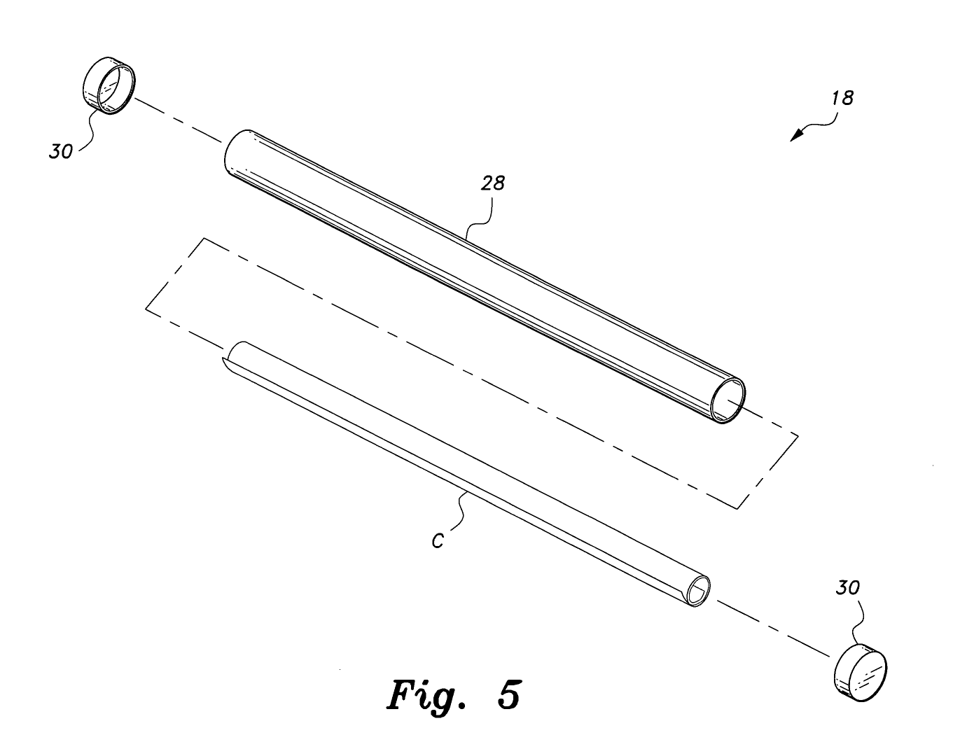

In the preferred embodiment, the openings 20 have a substantially circular shape for storing chart storage tubes 18. As shown in FIG. 5, each chart storage tube 18 includes a central tube portion 28, which is preferably formed as an elongated, cylindrical pipe that may be formed from polyvinyl chloride (PVC) or any other suitable waterproof material adapted for receiving a navigational chart C. The central tube portion 28 is shaped for removable insertion through a pair of the longitudinally aligned openings 20.

A pair of end caps 30 are provided for closing the opposed ends of the elongated pipe 28. As shown in FIG. 2, the openings 20 may be used for storing any suitable equipment, such as fishing net N and gaff G. Multiple chart storage tubes 18 are preferably provided and, in the preferred embodiment, each chart storage tube 18 is formed in different colors, allowing for the user to visually distinguish the charts from one another.

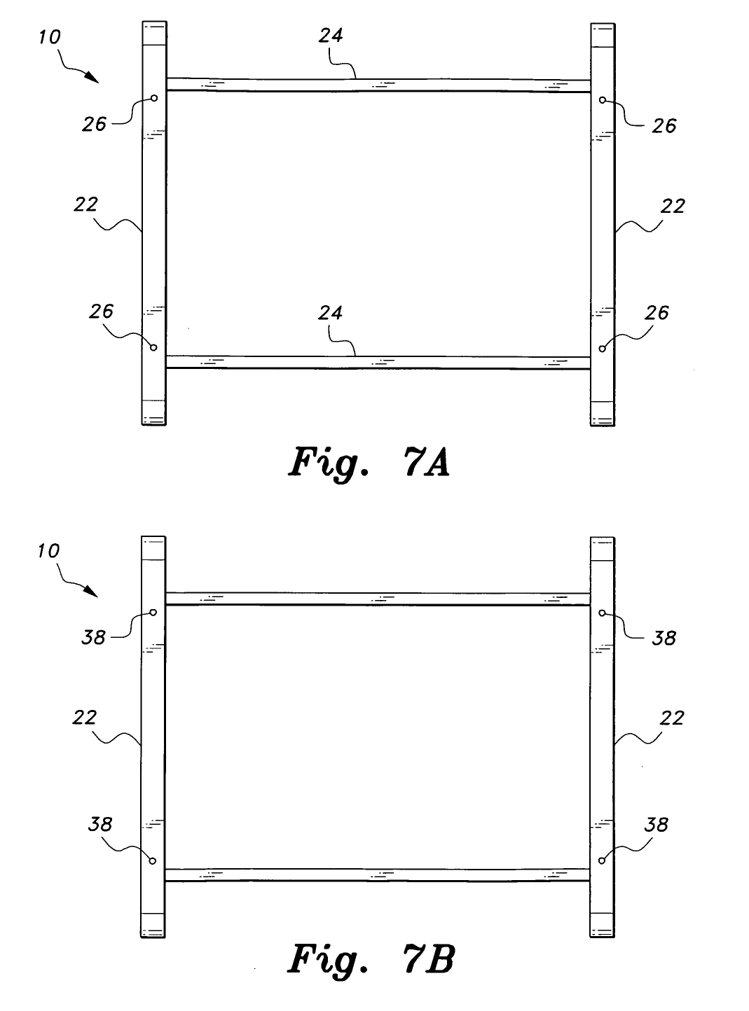

As shown in FIG. 2, roofs of boats are typically provided with mounting structures 16 for equipment housings 14. The mounting structures 16 typically have apertures or passages 34 formed therethrough (shown in FIG. 6) for receiving fasteners, such as bolts, screws or the like, for attaching the housing 14 thereto. As shown in FIGS. 7A and 7B, the upper surface of rack 10 is provided with threaded bores 26, and the lower surface of rack 10 is provided with threaded bores 38.

Rather than suspending the housing 14 directly from the mounting structures 16, the rack 10 is positioned therebetween. As shown in FIG. 6, threaded bolts 32 pass through passages or apertures 34 and are tightened in threaded bores 26 to attach the rack 10 to the mounting structures 16. Similarly, threaded bolts 36 pass through openings formed in the upper wall of housing 14 and engage threaded bores 38 to attach the housing 14 to the lower surface of the rack 10.

It should be understood that any suitable fasteners, such as screws, brackets, clamps, hangers, or the like, may be utilized to secure the rack 10 to mounting structures 16 and to secure the housing 14 to rack 10. Further, mounting structures 16 are shown for exemplary purposes only, and the rack 10 may be secured directly to the roof 12 or to any other suitable support surface, depending upon the particular nature of boat B. Once in place, the rack 10 allows for a lower positioning of housing 14 than is known in conventional boat configurations, providing the user with more comfortable and convenient access to housing 14. Further, charts C and other equipment may be stored within the rack 10.

It is to be understood that the present invention is not limited to the embodiments described above, but encompasses any and all embodiments within the scope of the following claims.

I claim:

1. An equipment rack for boats, comprising:
a pair of parallel rails and a pair of parallel beams joined together to form a substantially rectangular rack, the rails having pairs of aligned storage holes defined therein;
means for suspending the beams from a roof of a boat; and
means for suspending an equipment housing from the beams, whereby the equipment housing is spaced apart the roof of the boat.

2. The equipment rack for boats as recited in claim 1, wherein opposed ends of the rails are attached to inner surfaces of the beams.

3. The equipment rack for boats as recited in claim 3, wherein each of the rails is spaced apart opposed ends of the beams.

4. The equipment rack for boats as recited in claim 1, further comprising at least one chart storage tube having an open interior region adapted for receiving a chart, the at least one chart storage tube being slidably insertable through the storage holes for storing charts in the equipment rack.

5. The equipment rack for boats as recited in claim 4, wherein the at least one chart storage tube comprises:
an elongated pipe having longitudinally opposed open ends; and
a pair of caps for releasably closing the longitudinally opposed open ends of the elongated pipe.

6. The equipment rack for boats as recited in claim 1, wherein said means for suspending the beams from the roof of the boat comprises:
threaded bores defined in the beams; and
bolts engaging the threaded bores, the bolts being dimensioned and configured for extending through mounting structures attached to the roof of the boat.

7. The equipment rack for boats as recited in claim 1, wherein said means for suspending an equipment housing from the beams comprises:
threaded bores defined in the beams; and
bolts engaging the threaded bores, the bolts being dimensioned and configured for extending through an upper wall of the equipment housing.

8. An equipment and chart storage rack for boats, comprising:
a pair of parallel rails and a pair of parallel beams joined together to form a substantially rectangular rack, the rails having pairs of aligned storage holes defined therein;
means for suspending the beams from a roof of a boat;
means for suspending an equipment housing from the beams, whereby the equipment housing is spaced apart the roof of the boat; and
at least one chart storage tube having an open interior region adapted for receiving a chart, the at least one chart storage tube being slidably inserted through the storage holes for storing a chart in the rack.

9. The equipment rack and chart storage rack for boats as recited in claim 8, wherein opposed ends of the rails are attached to inner surfaces of the beams.

10. The equipment rack and chart storage rack for boats as recited in claim 8, wherein each of the rails is spaced apart from opposed ends of the beams.

11. The equipment rack and chart storage rack for boats as recited in claim 8, wherein the at least one chart storage tube comprises:
an elongated pipe having longitudinally opposed open ends; and
a pair of caps for closing the longitudinally opposed open ends of the elongated pipe.

12. The equipment rack and chart storage rack for boats as recited in claim 8, wherein said means for suspending the beams from the roof of the boat comprises:
threaded bores defined in the beams; and
bolts engaging the threaded bores, the bolts being dimensioned and configured for extending through mounting structures attached to the roof of the boat.

13. The equipment rack and chart storage rack for boats as recited in claim 8, wherein said means for suspending an equipment housing from the beams comprises:
threaded bores defined in the beams; and
bolts engaging the threaded bores, the bolts being dimensioned and configured for extending through an upper wall of the equipment housing.

14. An equipment rack for boats, comprising:
a pair of parallel rails and a pair of parallel beams joined together to form a substantially rectangular rack, the rails having pairs of aligned storage holes defined therein;
means for suspending the beams from a roof of a boat; and
an equipment housing having a shelf adapted for positioning navigational equipment above a user's head, the equipment housing being suspended from the beams.

15. The equipment rack for boats according to claim 14, further comprising a least one chart holder slidably insertable through one of the pairs of aligned storage holes.

16. The equipment rack for boats according to claim 15, wherein said chart holder comprises an elongated cylindrical tube having at least one removable end cap at one of the ends of the tube.

17. The equipment rack for boats according to claim 14, wherein said means for suspending the beams from the roof of the boat comprises:
threaded bores defined in the beams; and
bolts engaging the threaded bores, the bolts being dimensioned and configured for extending through mounting structures attached to the roof of the boat.
